(19) United States
(12) Patent Application Publication
(10) Pub. No.: US 2026/0024752 A1
(43) Pub. Date: Jan. 22, 2026

(54) Rechargeable Alkali Metal Battery Containing a Sodium Salt, Lithium Salt, or Potassium Salt Composite Cathode and Manufacturing Method

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/773,682

(22) Filed: Jul. 16, 2024

(51) Int. Cl. H01M 4/36; H01M 4/02; H01M 4/583; H01M 4/62; H01M 10/0525; H01M 10/054; H01M 10/0562; H01M 10/0565; H01M 10/0568

(52) U.S. Cl. CPC H01M 4/364; H01M 4/583; H01M 4/625; H01M 10/0525; H01M 10/054; H01M 10/0562; H01M 10/0565; H01M 10/0568; H01M 2004/021; H01M 2004/027; H01M 2004/028; H01M 2300/0068; H01M 2300/0082

(57) ABSTRACT

Provided is a cathode active material for a rechargeable alkali metal battery, wherein the cathode active material comprises a sodium salt composite comprising a mixture or composite of Fe and at least a sodium salt selected from NaₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof, wherein a molar ratio of Fe-to-sodium salt is from 1/9 to 9/1. Also provided is a rechargeable alkali metal battery comprising this cathode active material, which is a sodium battery (sodium-ion or sodium metal battery), a lithium battery (lithium-ion or lithium metal battery), or a potassium battery (potassium-ion or potassium metal battery).

### FIELD

The present disclosure is directed at the cathode of a sodium battery (sodium-ion or sodium metal battery), a lithium battery (lithium-ion or lithium metal battery), or a potassium battery (potassium-ion or potassium metal battery).

### BACKGROUND

Rechargeable lithium-ion (Li-ion) and lithium metal batteries (including Li-sulfur and Li metal-air batteries) are considered promising power sources for electric vehicle (EV), hybrid electric vehicle (HEV), and portable electronic devices, such as lap-top computers and mobile phones. Lithium as a metal element has the highest capacity (3,861 mAh/g) compared to any other metal or metal-intercalated compound as an anode active material (except Li_{4.4}Si, which has a specific capacity of 4,200 mAh/g). Hence, in general, Li metal batteries have a significantly higher energy density than lithium-ion batteries.

The energy density of a lithium battery (lithium-ion or lithium metal cell) is typically limited by the low specific density of its cathode active material, having a specific capacity of typically 150-250 mAh/g versus the typically 350-4,200 mAh/g of anode active materials (graphite and silicon). Further, most of the lithium batteries implemented in current electric vehicles make use of cathodes comprising nickel- and cobalt-based layered metal oxides, i.e., LiMO₂, such as LiNiₓCo, Al_{z}O₂ (NCA) and LiNiₓMn_{y}Co_{z}O₂ (NMC). Nickel and cobalt are currently mined in an environmentally unfriendly manner and forecast to be in short supply in the near future. The cathode accounts for over 50% of the cell cost of a lithium-ion cell.

Furthermore, lithium is not an abundant element in the earth's crust and lithium is only mined in a very limited number of countries. There is fear for short supply of lithium as the EV industry is rapidly emerging and, hence, the demand for lithium batteries can outpace the supply of lithium.

As a totally distinct class of energy storage device, sodium (Na) batteries have been considered an attractive alternative to lithium batteries since sodium is abundant and the production of sodium is significantly more environmentally benign compared to the production of lithium. In addition, the high cost of lithium is a major issue and Na batteries potentially can be of significantly lower cost. However, the significantly lower energy densities (typically with a specific energy in the range 100-160 Wh/kg) of sodium cells are a major barrier to their widespread commercialization; lithium-ion cells typically have a specific energy of 160-350 Wh/kg or higher.

There are at least two types of sodium batteries that operate on bouncing sodium ions (Na⁺) back and forth between an anode and a cathode: the sodium metal battery having Na metal or alloy as the anode active material and the sodium-ion battery having a Na intercalation compound or Na alloying compound as the anode active material. Sodium ion batteries using a hard carbon-based anode active material (a Na intercalation compound) and a sodium transition metal phosphate as a cathode have been described by several research groups; e.g., J. Barker, et al. “Sodium Ion Batteries,” U.S. Pat. No. 7,759,008 (Jul. 20, 2010).

Instead of hard carbon or other carbonaceous intercalation compound, sodium metal may be used as the anode active material in a sodium metal cell. Despite the notion that the use of metallic sodium as the anode active material can significantly increase the energy density of a sodium battery, the low cathode capacity remains a bottleneck or barrier to the development of a sodium battery having a higher energy that is comparable to that of a lithium-ion battery.

There are three types of cathode (positive electrode) active materials that are commonly used in sodium batteries: transition metal oxides (e.g., tunnel-type and layered-type metal oxides), polyanionic compounds (phosphates, sulfates, and mixed anion materials), and ferrocyanide materials (e.g., Prussian blue and Prussian white). The specific capacities of current cathode active materials are too low to enable a sodium cell with a high energy density. They are typically lower than 250 mAh/g, more typically lower than 200 mAh/g, and most typically lower than 150 mAh/g. Potassium batteries typically have even lower energy densities due to the low specific capacities of both the anode and cathode materials.

Clearly, an urgent need exists for a cathode active material having a higher specific capacity, preferably higher than 250 mAh/g. A specific object of the present disclosure is to provide a sodium battery (sodium-ion or sodium metal battery), a lithium battery (lithium-ion or lithium metal battery), or a potassium battery (potassium-ion or potassium metal battery) featuring a higher capacity cathode, leading to a high specific energy.

### SUMMARY

The present invention provides a cathode active material for a rechargeable alkali metal battery, which is a sodium battery (sodium-ion or sodium metal battery), lithium battery (lithium-ion or lithium metal battery), or potassium battery (potassium-ion or potassium metal battery), wherein the cathode active material comprises a sodium salt composite comprising a mixture or composite of Fe and at least a sodium salt selected from NaₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof, wherein a molar ratio of Fe-to-sodium salt is from 1/9 to 9/1.

In certain embodiments, the sodium salt composite further meets at least one of the following criteria:
(i) at least two anions, selected from the group consisting of F⁻, Cl⁻, Br⁻, I⁻¹, PO₄³⁻, SO₄²⁻, CO₃²⁻, SiO₃²⁻, NO₃⁻, and B₄O₇²⁻, form a solid solution;
(ii) the mixture or composite further comprises at least a lithium salt selected from LiₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof (lithium salt can be from 1% to 99% of the total mixture or composite weight);
(iii) the mixture or composite further comprises at least a potassium salt selected from KₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof (potassium salt can be from 1% to 99% of the total mixture or composite weight); and
(iv) the mixture or composite further comprises a conductive material selected from graphite, hard carbon, soft carbon, carbon black, acetylene black, activated carbon, carbon fibers, carbon nanotubes, graphene sheets, or a combination thereof (conductive material can be from 1% to 30% of the total mixture or composite weight, preferably from 5% to 20%).

Desirably, a first anion selected from the group consisting of F⁻, Cl⁻, Br⁻, and I⁻¹ and a second anion selected from the group consisting of PO₄³⁻, SO₄²⁻, CO₃²⁻, SiO₃²⁻, NO₃⁻, and B₄O₇²⁻ form a solid solution. For instance, NaF and NaPO₄³ or LiF and LiPO₄³ can form a solid solution.

The present disclosure also provides a rechargeable alkali metal cell, comprising an anode, a cathode comprising the aforementioned cathode active material (a sodium salt composite, possibly comprising other salts and conductive additives, etc.), a separator disposed between the cathode and the anode, and an electrolyte in ionic contact with the anode and the cathode, wherein the alkali metal cell is a sodium-ion cell, sodium metal cell, lithium-ion cell, lithium metal cell, potassium-ion cell, or potassium metal cell. The electrolyte itself, if a solid-state electrolyte, can be a separator.

In some embodiments, the anode has an anode current collector, but initially the anode has no sodium, sodium alloy, lithium, lithium alloy, potassium, or potassium alloy as an anode active material supported by the anode current collector when the battery cell is made and prior to a charge or discharge operation of the battery. The anode active material (e.g., Na, Li, or K) is initially stored in the cathode and the Na⁺, Li⁺, or K⁺ ions come out of cathode during the first and subsequent battery charging procedures, travel through the electrolyte and get to deposit on the anode current collector (e.g., a Cu foil). Such a cell is herein referred to as an anodeless lithium, sodium, or potassium battery.

In some other embodiments, the anode has an anode current collector and an amount of sodium, sodium alloy, lithium, lithium alloy, potassium, or potassium alloy, or a combination thereof (e.g., in the form of powder, coating, or thin film) as an anode active material supported by the anode current collector.

The electrolyte in the battery may comprise a liquid organic electrolyte, ionic liquid electrolyte, gel polymer electrolyte, quasi-solid electrolyte having a sodium salt concentration higher than 2.0 M (preferably >3 M) dispersed in a liquid, solid polymer electrolyte, inorganic solid electrolyte, composite electrolyte comprising particles of an inorganic solid dispersed in or bonded by a polymer, or a combination thereof, wherein the electrolyte has a sodium ion conductivity, lithium ion conductivity, or potassium ion conductivity no less than 106 S/cm.

In the rechargeable alkali metal cell, the electrolyte may comprise a lithium salt, a sodium salt, a potassium salt, or a combination thereof. The electrolyte preferably comprises a sodium salt selected from sodium perchlorate (NaClO₄), sodium chlorate (NaClO₃), sodium hexafluorophosphate (NaPF₆), sodium borofluoride (NaBF₄), sodium hexafluoroarsenide, sodium trifluoro-metasulfonate (NaCF₃SO₃), bis-trifluoromethyl sulfonylimide sodium (NaN(CF₃SO₂)₂), sodium trifluoromethanesulfonimide (NaTFSI), sodium bis(fluoroallyl) malonato borate salt (NaBFMB), sodium poly(tartaric acid)borate (NaPTAB) salt, NaCF₃COO, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, wherein X=F⁻, Cl, I, or Br, R=a hydrocarbon group, x=0-1, y=1-4, or a combination thereof.

The electrolyte may comprise a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The electrolyte preferably has a sodium ion conductivity, lithium ion conductivity, or potassium ion conductivity no less than 10⁻⁵ S/cm, further preferably no less than 10⁻⁴ S/cm, and most preferably no less than 10⁻³ S/cm.

The electrolyte may comprise a sodium ion-conducting polymer selected from poly(ethylene oxide) (PEO), Polypropylene oxide (PPO), polyethylene glycol (PEG), polyvinyl alcohol (PVA), poly(vinyl pyrrolidone) (PVP), poly(ethyl methacrylate) (PEMA), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

In some embodiments, the electrolyte comprises a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanocthyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-malcic anhydride), polycaprolactone, poly(trimethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

The electrolyte may comprise an inorganic solid electrolyte selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof, or wherein the composite electrolyte comprises particles of a ceramic or glass material dispersed in a polymer and the particles are selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F⁻, Cl, I, or Br, R=a hydrocarbon group, x=0-1, y=1-4.

The rechargeable alkali metal cell may be a sodium-ion cell wherein the anode has an anode active material other than, or in addition to, sodium or a sodium alloy, wherein the anode active material is selected from meso-phase pitch, meso-phase carbon, meso carbon micro-beads (MCMB), coke particles (e.g., needle coke), expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, carbon black, amorphous carbon, activated carbon, templated carbon, hollow carbon nanowires, hollow carbon sphere, silicon (Si), phosphorus (P), sodium titanates, NaTi₂(PO₄)₃, Na₂Ti₃O₇, Na₂C₈H₄O₄, Na₂TP, NaₓTiO₂ (x=0.2 to 1.0), disodium terephthalate (Na₂C₈H₄O₄), carboxylate based materials, C₈H₄Na₂O₄, C₈H₆O₄, C₈H₅NaO₄, C₈Na₂F₄O₄, C₁₀H₂Na₄O₈, C₁₄H₄O₆, C₁₄H₄Na₄O₈, or a combination thereof.

The rechargeable alkali metal cell may comprise an alkali intercalation compound, alkali metal alloying, or conversion-type compound as an anode active material, which may be selected from the following groups of materials: (a) Sodium- or potassium-doped silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof; (b) Sodium- or potassium-containing alloys or intermetallic compounds of Si, Ge, Sn, Pb, Sb, Bi, Zn, Al, Ti, Co, Ni, Mn, Cd, and their mixtures; (c) Sodium- or potassium-containing oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof; (d) Sodium or potassium salts; and (e) Graphene sheets pre-loaded or pre-attached with sodium ions (herein referred to as pre-sodiated graphene sheets).

The carbon or graphite material in the anode may be selected from those having an expanded inter-graphene planar spacing. For instance, meso-phase pitch, meso-phase carbon, meso carbon micro-beads (MCMB), coke particles, expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof, wherein the carbon or graphite material has an inter-planar spacing d₀₀₂ from 0.27 nm to 0.42 nm prior to a chemical or physical expansion treatment and the inter-planar spacing d₀₀₂.is increased to from 0.43 nm to 3.0 nm after the expansion treatment.

In certain embodiments, the carbon or graphite material is selected from graphite foam or graphene foam having pores and pore walls, wherein the pore walls contain a stack of bonded graphene planes having an expanded inter-planar spacing d₀₀₂ from 0.45 nm to 1.5 nm. Preferably, the stack contains from 2 to 100 graphene planes.

In the disclosed rechargeable alkali metal-ion cell, the inter-planar spacing d₀₀₂ may be from 0.5 nm to 1.2 nm. Preferably, the inter-planar spacing door is from 1.2 nm to 2.0 nm.

In some preferred embodiments, the expansion treatment may include an oxidation, fluorination, bromination, chlorination, nitrogenation, intercalation, combined oxidation-intercalation, combined fluorination-intercalation, combined bromination-intercalation, combined chlorination-intercalation, or combined nitrogenation-intercalation of the graphite or carbon material. These expansion treatments may be further followed by a constrained thermal expansion treatment to increase the d spacing from a more typical range of 0.5-1.2 nm to a range of 1.2-3.0 nm.

The carbon or graphite material may contain a non-carbon element selected from oxygen, fluorine, chlorine, bromine, iodine, nitrogen, hydrogen, or boron.

The present disclosure also provides an anode for a rechargeable alkali metal-ion cell, wherein the anode comprises a graphite or carbon material having expanded inter-graphene planar spaces with an inter-planar spacing d₀₀₂ from 0.43 nm to 3.0 nm, as measured by X-ray diffraction, and the expanded inter-graphene planar spaces store sodium or potassium ions to a specific capacity no less than 150 mAh/g (preferably and typically greater than 250 mAh/g) when the cell is in a charged state.

In certain embodiments, the electrolyte contains a salt selected from sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), bis-trifluoromethyl sulfonylimide potassium (KN(CF₃SO₂)₂), an ionic liquid salt, a combination thereof, or a combination with lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂, Lithium bis(oxalato)borate (LiBOB), lithium oxalyldifluoroborate (LiBF₂C₂O₄), lithium oxalyldifluoroborate (LiBF₂C₂O₄), Lithium nitrate (LiNO₃), Li-Fluoroalkyl-Phosphates (LiPF₃(CF₂CF₃)₃), or lithium bisperfluoroethysulfonylimide (LiBETI).

The solvent in the electrolyte may be selected from ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (Y-BL), acetonitrile (AN), ethyl acetate (EA), propyl formate (PF), methyl formate (MF), toluene, xylene or methyl acetate (MA), fluoroethylene carbonate (FEC), vinylene carbonate (VC), allyl ethyl carbonate (AEC), 1,3-dioxolane (DOL), 1,2-dimethoxyethane (DME), tetraethylene glycol dimethylether (TEGDME), Poly(ethylene glycol) dimethyl ether (PEGDME), diethylene glycol dibutyl ether (DEGDBE), 2-ethoxyethyl ether (EEE), sulfone, sulfolane, room temperature ionic liquid, or a combination thereof.

In certain embodiments, the cathode further comprises a cathode active material selected from NaFePO₄, Na₍₁₋ₓ₎KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ (Fe_{1/2}Mn_{1/2})O₂, NaₓMnO₂, λ-MnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y}, y/z=0.01 to 100, Se, sodium polysulfide, sulfur, Alluaudites, or a combination thereof, wherein x is from 0.1 to 1.0.

In some embodiments, the cathode further comprises a cathode active material selected from a Na-based layered oxide (e.g., O3-type, P2-type, or P3-type), a polyanionic compound, a mixed polyanionic compound, a sulfate, a pyrophosphate, a Prussian Blue analog, or a combination thereof. In some specific embodiments, the cathode comprises a cathode active material selected from Na_{0.7}CoO₂, Na_{0.67}Ni_{0.25}Mg_{0.1}Mn_{0.65}O₂, Na_{0.5}[Ni_{0.23}Fe_{0.13}Mn_{0.63}]O₂, Na_{0.85}Li_{0.17}Ni_{0.21} Mn_{0.64}O₂, Zn doped Na_{0.833}[Li_{0.25}Mn_{0.75}]O₂, Na_{0.7}Mg_{0.05}[Mn_{0.6} Ni_{0.2}Mg_{0.15}]O₂, Na_{0.66}Co_{0.5}Mn_{0.5}O₂, Na₂₃Li₁₉Ni_{5/18}Mn_{2/3}O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48} Ni_{0.2}Fe_{0.3}Mg_{0.02}O₂, V₂O₅ nanosheet, Na₃V₂(PO₄)₃, Na₃V₂(PO₄)₃/C, Na₃MnZr(PO₄)₃, Na₄Fe₃(PO₄)₂ (P₂O₇), Na₃MnTi(PO₄)₃/C, carbon coated Na₃V₂(PO₄)₂F₃, Na₃(VOPO₄)₂F, graphene oxide protected Na₂₊₂ₓFC₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

In certain embodiments, the rechargeable alkali metal cell is a potassium battery wherein the cathode active material further comprises at least a potassium salt selected from KₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof.

In certain embodiments, the rechargeable alkali metal cell is a lithium battery wherein the cathode active material further comprises at least a lithium salt selected from LiₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof. This is in addition to the sodium salt composite comprising a mixture or composite of Fe and at least a sodium salt selected from NaₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof, wherein a molar ratio of Fe-to-sodium salt is from 1/9 to 9/1.

The present disclosure further provides a rechargeable alkali metal cell (a lithium-ion cell or lithium metal cell), comprising an anode, a cathode comprising a cathode active material, a separator disposed between the cathode and the anode, and an electrolyte in ionic contact with the anode and the cathode, wherein the cathode active material comprises a lithium salt composite comprising a mixture or composite of Fe and at least a lithium salt selected from LiₓA, wherein x is from 1 to 3, and the anion A^{x-} is selected from Cl⁻, Br⁻, I⁻¹, PO₄³⁻, SO₄²⁻, CO₃²⁻, SiO₃²⁻, NO₃⁻, B₄O₇²⁻, a combination thereof, or a combination of Cl⁻, Br⁻, I⁻¹, SO₄²⁻, CO₃²⁻, SiO₃²⁻, NO₃⁻, or B₄O₇²⁻ with F.

The present invention also provides a process for manufacturing the disclosed cathode active material, the process comprising: (a) providing Fe powder, a first sodium salt selected from NaF, NaCl, NaBr, NaI, or a combination thereof, and a second sodium salt selected from Na₃PO₄, Na₂SO₄, Na₂CO₃, Na₂SiO₃, NaNO₃, Na₂B₄O₇, or a combination thereof; (b) mixing the Fe powder, the first sodium salt, and the second salt at a molar ratio of Fe-to-(combined first and second sodium salts) from 1/9 to 9/1 and a first-to-second sodium salt ratio from 1/3 to 3/1 to form a solid particle mixture; and (c) ball-milling the solid particle mixture at a first temperature under a protective atmosphere for a first period of time to obtain the desired sodium salt composite.

In certain embodiments, step b) comprises (i) dissolving the first sodium salt and the second sodium salt in a common liquid solvent to form a liquid salt solution; (ii) dispersing Fe particles, having a diameter or thickness from 5 nm to 10 μm, in the salt solution to form a slurry; and (iii) removing the liquid solvent to form a solid particle mixture.

Preferably, the step of removing the liquid solvent is conducted in such a manner that Fe particles are coated with or encapsulated by a solid layer of a mixture of the first sodium salt and the second sodium salt. This can be accomplished by using a procedure such as spray-drying, printing (e.g., inkjet printing), casting (to form a film which is possibly broken into particles using any mechanical breaking means, such as air jet milling), pan-coating, air-suspension coating or fluidized bed coating, centrifugal extrusion, vibrational nozzle coating, or a combination thereof. This step results in a highly homogeneous mixture of Fe particles and the first and second sodium salts, wherein Fe particles are always surrounded or contacted by the first and/or the second sodium salt, making a highly effective cathode active material that delivers the highest specific capacity.

These and other advantages and features of the present invention will become more transparent with the description of the following best mode practice and illustrative examples.

### BRIEF DESCRIPTION OF THE DRAWINGS

FIG. 1 Schematic of a prior art sodium metal battery cell or sodium-ion cell, containing an anode layer (e.g., a thin Na foil or a hard carbon-containing layer deposited on a surface of a current collector, Cu foil), a porous separator, and a cathode active material layer, which is composed of particles of a cathode active material, a conductive additive (not shown) and a resin binder (not shown). A cathode current collector supporting the cathode active layer is also shown.

FIG. 2(A) Schematic of a presently invented sodium metal battery cell (upper diagram) containing an anode current collector (e.g., Cu foil) but no anode active material (when the cell is manufactured or in a fully discharged state), an ion-permeable membrane (or separator), and a cathode active material layer, which is composed of particles of a cathode active material comprising the disclosed sodium salt composite. A cathode current collector supporting the cathode active layer is also shown. The lower diagram shows a thin lithium metal layer deposited between the Cu foil and the separator layer when the battery is in a charged state;

FIG. 2(B) Schematic of a presently invented sodium-ion battery cell.

FIG. 3 Flowchart that summarizes a process for producing Fe/sodium salt composite cathode active materials according to certain embodiments of the present disclosure.

### DETAILED DESCRIPTION

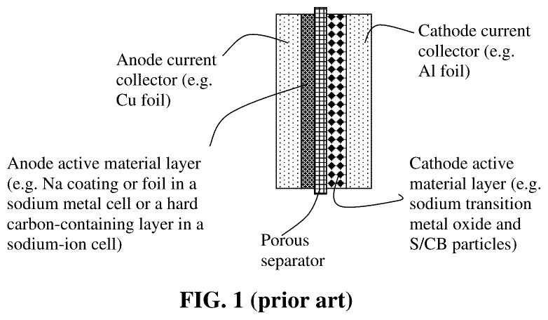

For illustration purposes, FIG. 1 schematically shows a typical alkali metal cell (e.g., a sodium metal cell or sodium-ion cell), containing an anode layer (e.g., a thin Na foil for a sodium metal cell or a hard carbon-containing layer for a sodium-ion cell) deposited on a surface of an anode current collector (Cu foil), a porous separator, and a cathode active material layer, which is typically composed of particles of a cathode active material, a conductive additive, and a resin binder. A cathode current collector (e.g., Al foil) supporting the cathode active layer is also shown.

As recited the Background section, there are three types of cathode active materials commonly used in prior art sodium batteries: transition metal oxides (e.g., tunnel-type and layered-type metal oxides), polyanionic compounds (phosphates, sulfates, and mixed anion materials), and ferrocyanide materials (e.g., Prussian blue and Prussian white). The specific capacities (typically lower than 250 mAh/g, more typically less than 200 mAh/g, and most typically lower than 150 mAh/g) of current cathode active materials are too low to enable a sodium cell with a high energy density.

The present invention provides a cathode active material for a rechargeable alkali metal battery, which is a sodium battery (sodium-ion or sodium metal battery), lithium battery (lithium-ion or lithium metal battery), or potassium battery (potassium-ion or potassium metal battery), wherein the cathode active material comprises a sodium salt composite comprising a mixture or composite of Fe and at least a sodium salt selected from NaₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof, wherein a molar ratio of Fe-to-sodium salt is from 1/9 to 9/1.

In certain embodiments, the sodium salt composite further meets at least one of the following criteria: (i) at least two anions, selected from the group consisting of F⁻, Cl⁻, Br⁻, I⁻¹, PO₄³⁻, SO₄²⁻, CO₃²⁻, SiO₃²⁻, NO₃⁻, and B₄O₇²⁻, form a solid solution; (ii) the mixture or composite further comprises at least a lithium salt selected from LiₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof (lithium salt can be from 1% to 99% of the total mixture or composite weight); (iii) the mixture or composite further comprises at least a potassium salt selected from KₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof (potassium salt can be from 1% to 99% of the total mixture or composite weight); and (iv) the mixture or composite further comprises a conductive material selected from graphite, hard carbon, soft carbon, carbon black, acetylene black, activated carbon, carbon fibers, carbon nanotubes, graphene sheets, or a combination thereof (conductive material can be from 1% to 30% of the total mixture or composite weight, preferably from 5% to 20%).

These cathode active materials deliver a specific capacity typically in the range of 200 to 400 mAh/g (if used in a lithium battery), 150 to 350 mAh/g (if used in a sodium battery), and 120-270 mAh/g (if used in a potassium battery).

In a desirable or preferred situation, a first anion selected from the group consisting of F⁻, Cl⁻, Br⁻, and I⁻¹ and a second anion selected from the group consisting of PO₄³⁻, SO₄²⁻, CO₃²⁻, SiO₃²⁻, NO₃⁻, and B₄O₇²⁻ form a solid solution. For instance, NaF and NaPO₄³ or LiF and LiPO₄³ can form a solid solution.

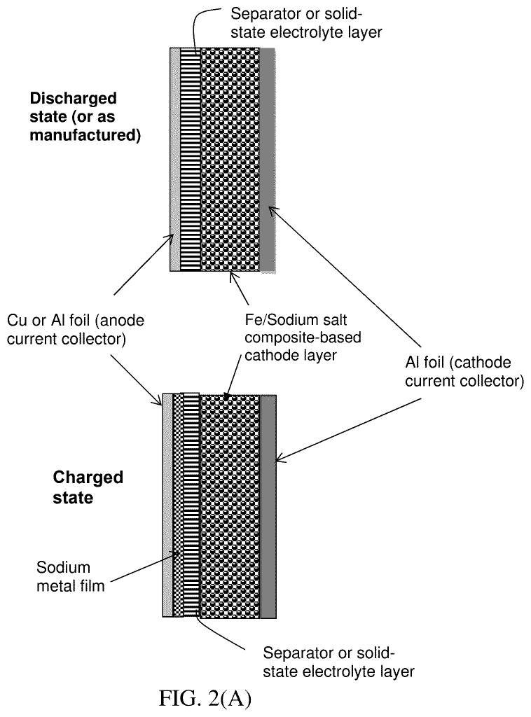

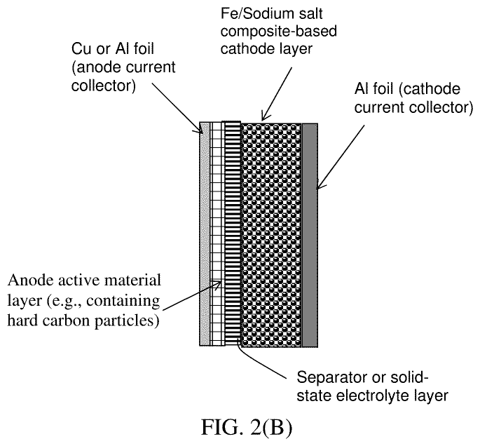

The present disclosure also provides a rechargeable alkali metal cell, comprising an anode, a cathode comprising the aforementioned cathode active material (a sodium salt composite, possibly comprising other alkali metal salts and conductive additives, etc.), a separator disposed between the cathode and the anode, and an electrolyte, wherein the alkali metal cell is a sodium-ion cell, sodium metal cell, lithium-ion cell, lithium metal cell, potassium-ion cell, or potassium metal cell. Schematically shown in FIG. 2(A) is an alkali metal cell having an alkali metal as an anode active material and a sodium salt composite herein disclosed as a cathode active material. Schematically shown in FIG. 2(B) is an alkali metal-ion cell having a carbon-based (e.g., hard carbon, soft carbon, graphite, and graphene), conversion reaction-based (metal oxides/sulfides/phosphides), or alloying reaction-based (e.g., Si, Ge, Sn, and Pb) anode active material and a sodium salt composite herein disclosed as a cathode active material.

In some embodiments, as illustrated in the upper portion of FIG. 2(A), the anode has an anode current collector but initially the anode has no sodium, sodium alloy, lithium, lithium alloy, potassium, or potassium alloy as an anode active material supported by the anode current collector when the battery cell is made and prior to a charge or discharge operation of the battery. This is herein referred to as an anodeless sodium metal battery, anodeless lithium metal battery, or anodeless potassium metal alloy. The anode active material (e.g., Na, Li, or K) is initially stored in the cathode and the Na⁺, Li⁺, or K⁺ ions come out of cathode during the first and subsequent battery charging procedures, travel through the electrolyte and get to deposit on the anode current collector (e.g., a Cu foil), as schematically illustrated in the lower portion of FIG. 2(A).

In some other embodiments, the anode has an anode current collector and an amount of sodium, sodium alloy, lithium, lithium alloy, potassium, or potassium alloy, or a combination thereof (e.g., in the form of powder, coating, or thin film) as an anode active material supported by the anode current collector.

In some embodiments, the rechargeable sodium cell is a sodium-ion cell (e.g., FIG. 2(B)) as an example, wherein the anode active material contains an alkali intercalation compound (e.g., carbon), a conversion compound (e.g., metal oxide/sulfide/phosphide), or an alloying reaction material (Si, Ge, Sn, etc.).

In a typical configuration (again using sodium battery as an example of an alkali metal battery), the separator is in ionic contact with both the anode and the cathode and typically in physical contact with an anode active material layer (or an anode current collector) and with a cathode active material layer. The anode and/or the cathode may also contain a working electrolyte to facilitate sodium ion transport in the electrodes. Thus, a battery cell may further comprise, in addition to the separator serving as a solid electrolyte, a working electrolyte in ionic contact with an anode active material and/or a cathode active material wherein the working electrolyte is selected from an organic liquid electrolyte, ionic liquid electrolyte, polymer gel electrolyte, solid polymer electrolyte, inorganic solid electrolyte, quasi-solid electrolyte having a sodium salt dissolved in an organic or ionic liquid with a sodium salt concentration higher than 2.0 M (preferably from 2.5M to 14 M), a polymer composite electrolyte, or a combination thereof.

In the rechargeable alkali metal cell (e.g., sodium battery), the electrolyte may comprise a lithium salt, a sodium salt, a potassium salt, or a combination thereof. The electrolyte preferably comprises a sodium salt selected from sodium perchlorate (NaClO₄), sodium chlorate (NaClO₃), sodium hexafluorophosphate (NaPF₆), sodium borofluoride (NaBF₄), sodium hexafluoroarsenide, sodium trifluoro-metasulfonate (NaCF₃SO₃), bis-trifluoromethyl sulfonylimide sodium (NaN(CF₃SO₂)₂), sodium trifluoromethanesulfonimide (NaTFSI), sodium bis(fluoroallyl) malonato borate salt (NaBFMB), sodium poly(tartaric acid)borate (NaPTAB) salt, NaCF₃COO, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, wherein X=F⁻, Cl, I, or Br, R=a hydrocarbon group, x=0-1, y=1-4, or a combination thereof.

The electrolyte for a lithium battery may comprise a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The electrolyte preferably has a sodium ion conductivity, lithium ion conductivity, or potassium ion conductivity no less than 10⁻⁵ S/cm, further preferably no less than 10⁻⁴ S/cm, and most preferably no less than 10⁻³ S/cm.

The solid electrolyte may comprise an inorganic solid electrolyte material having a sodium ion conductivity no less than 10⁻⁸ S/cm, preferably no less than 106 S/cm, more preferably no less than 10⁻⁴ S/cm, and most preferably no less than 10⁻³ S/cm. Certain complex sulfide, halide, or hydride type solid-state electrolytes can have a sodium ion conductivity greater than 10⁻² S/cm.

Several different types of Na⁺-ion solid-state electrolytes (SSE) are available as an ion conductivity enhancer. These include beta-alumina, NASICON, sulfide-based electrolytes, complex hydrides, and organic electrolytes. NASICON materials include Na₁₊ₓZr₂SiₓP₃₋ₓO₁₂ (0≤x≤3). This abbreviation is used for phosphates with the generic formula AMP₃O₁₂. In this family of compositions, a wide variation of substitutions has been reported. For instance, the A-site can be occupied by:
monovalent cations: Li⁺, Na⁺, K⁺, Rb⁺, Cs⁺, H⁺, H₃O⁺, NH⁴⁺, Cu⁺, Ag⁺,
divalent cations: Mg²⁺, Ca²⁺, Sr²⁺, Ba²⁺, Cu²⁺, Pb²⁺, Cd²⁺, Mn²⁺, Co²⁺, Ni²⁺, Zn²⁺,
trivalent cations: Al³⁺, Y³⁺, La³⁺—Lu³⁺,
tetravalent cations: Ge⁴⁺, Zr⁴⁺, Hf⁴⁺;

Or it can also be vacant in the case that the M-site is occupied by pentavalent cations. The M sites can be occupied by:
divalent cations: Cd²⁺, Mn²⁺, Co²⁺, Ni²⁺, Zn²⁺,
trivalent cations: Al³⁺, Ga³⁺, In³⁺, Sc³⁺, Ti³⁺, V³⁺, Cr³⁺, Fe³⁺, Y³⁺, La³⁺—Lu³⁺,
tetravalent cations: Si⁴⁺, Ge⁴⁺, Sn⁴⁺, Ti⁴⁺, Zr⁴⁺, Hf⁴⁺, V⁴⁺, Nb⁴⁺, Mo⁴⁺, and
pentavalent cations: V⁵⁺, Nb⁵⁺, Ta⁵⁺, Sb⁵⁺, As⁵⁺ to balance the charge suitably. In addition, phosphorus has been partially substituted by Si, Ge or As.

In certain embodiments, the electrolyte for a sodium battery comprises a sodium salt selected from sodium perchlorate (NaClO₄), sodium chlorate (NaClO₃), sodium hexafluorophosphate (NaPF₆), sodium borofluoride (NaBF₄), sodium hexafluoroarsenide, sodium trifluoro-metasulfonate (NaCF₃SO₃), bis-trifluoromethyl sulfonylimide sodium (NaN(CF₃SO₂)₂), sodium trifluoromethanesulfonimide (NaTFSI), sodium bis(fluoroallyl) malonato borate salt (NaBFMB), sodium poly(tartaric acid)borate (NaPTAB) salt, NaCF₃COO, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, wherein X=F⁻, Cl, I, or Br, R=a hydrocarbon group, x=0-1, y=1-4, or a combination thereof.

The sodium ion-conducting polymer (gel or solid polymer electrolyte) may be selected from poly(ethylene oxide) (PEO), Polypropylene oxide (PPO), polyethylene glycol (PEG), polyvinyl alcohol (PVA), poly(vinyl pyrrolidone) (PVP), poly(ethyl methacrylate) (PEMA), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

The rechargeable sodium cell may be a sodium-ion cell wherein the anode active material contains an alkali intercalation compound selected from meso-phase pitch, meso-phase carbon, meso carbon micro-beads (MCMB), coke particles (e.g., needle coke), expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, carbon black, amorphous carbon, activated carbon, templated carbon, hollow carbon nanowires, hollow carbon sphere, silicon (Si), phosphorus (P), sodium titanates, NaTi₂(PO₄)₃, Na₂Ti₃O₇, Na₂C₈H₄O₄, Na₂TP, NaₓTiO₂ (x=0.2 to 1.0), disodium terephthalate (Na₂C₈H₄O₄), carboxylate based materials, C₈H₄Na₂O₄, C₈H₆O₄, C₈H₅NaO₄, C₈Na₂F₄O₄, C₁₀H₂Na₄O₈, C₁₄H₄O₆, C₁₄H₄Na₄O₈, or a combination thereof.

The alkali intercalation compound or alkali-containing compound as an anode active material may be selected from the following groups of materials: (a) Sodium- or potassium-doped silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof; (b) Sodium- or potassium-containing alloys or intermetallic compounds of Si, Gc, Sn, Pb, Sb, Bi, Zn, Al, Ti, Co, Ni, Mn, Cd, and their mixtures; (c) Sodium- or potassium-containing oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof; (d) Sodium or potassium salts; and (c) Graphene sheets pre-loaded or pre-attached with sodium ions (herein referred to as pre-sodiated graphene sheets).

The carbon or graphite material in the anode may be selected from those having an expanded inter-graphene planar spacing. For instance, meso-phase pitch, meso-phase carbon, meso carbon micro-beads (MCMB), coke particles, expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof, wherein the carbon or graphite material has an inter-planar spacing d₀₀₂ from 0.27 nm to 0.42 nm prior to a chemical or physical expansion treatment and the inter-planar spacing d₀₀₂.is increased to from 0.43 nm to 3.0 nm after the expansion treatment.

In certain embodiments, the carbon or graphite material is selected from graphite foam or graphene foam having pores and pore walls, wherein the pore walls contain a stack of bonded graphene planes having an expanded inter-planar spacing d₀₀₂ from 0.45 nm to 1.5 nm. Preferably, the stack contains from 2 to 100 graphene planes.

In the disclosed rechargeable sodium-ion cell, the inter-planar spacing d₀₀₂ may be from 0.5 nm to 1.2 nm. Preferably, the inter-planar spacing door is from 1.2 nm to 2.0 nm.

In some preferred embodiments, the expansion treatment may include an oxidation, fluorination, bromination, chlorination, nitrogenation, intercalation, combined oxidation-intercalation, combined fluorination-intercalation, combined bromination-intercalation, combined chlorination-intercalation, or combined nitrogenation-intercalation of the graphite or carbon material. These expansion treatments may be further followed by a constrained thermal expansion treatment to increase the d spacing from a more typical range of 0.5-1.2 nm to a range of 1.2-3.0 nm. The carbon or graphite material may contain a non-carbon element selected from oxygen, fluorine, chlorine, bromine, iodine, nitrogen, hydrogen, or boron.

In certain embodiments, the cathode further comprises a cathode active material selected from NaFePO₄, Na₍₁₋ₓ₎KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ (Fe_{1/2}Mn_{1/2})O₂, NaₓMnO₂, λ-MnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y}, y/z=0.01 to 100, Se, sodium polysulfide, sulfur, Alluaudites, or a combination thereof, wherein x is from 0.1 to 1.0.

In some embodiments, the cathode further comprises a cathode active material selected from a Na-based layered oxide (e.g., O3-type, P2-type, or P3-type), a polyanionic compound, a mixed polyanionic compound, a sulfate, a pyrophosphate, a Prussian Blue analog, or a combination thereof. In some specific embodiments, the cathode comprises a cathode active material selected from Na_{0.7}CoO₂, Na_{0.67}Ni_{0.25}Mg_{0.1} Mn_{0.65}O₂, Na_{0.5}[Ni_{0.23}Fe_{0.13}Mn_{0.63}]O₂, Na_{0.85}Li_{0.17}Ni_{0.21} Mn_{0.64}O₂, Zn doped Na_{0.833}[Li_{0.2.5}Mn_{0.75}]O₂, Na_{0.7}Mg_{0.05}[Mn_{0.6} Ni_{0.2}Mg_{0.15}]O₂, Na_{0.66}Co_{0.5}Mn_{0.5}O₂, Na_{2/3}Li_{1/9}Ni_{5/18}Mn_{2/3}O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48} Ni_{0.2}Fe_{0.3}Mg_{0.02}O₂, V₂O₅ nanosheet, Na₃V₂(PO₄)₃, Na₃V₂(PO₄)₃/C, Na₃MnZr(PO₄)₃, Na₄Fe₃(PO₄)₂(P₂O₇), Na₃MnTi(PO₄)₃/C, carbon coated Na₃V₂(PO₄)₂F₃, Na₃(VOPO₄)₂F, graphene oxide protected Na₂₊₂ₓFC₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

The working electrolyte may comprise a solvent selected from 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, a room temperature ionic liquid solvent, or a combination thereof.

The electrolyte may further comprise an alkali metal salt selected from sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), and bis-trifluoromethyl sulfonylimide potassium (KN(CF₃SO₂)₂), or a combination thereof. The content of aforementioned electrolytic salts in the non-aqueous solvent is preferably 0.5 to 3.0 M (mol/L) at the cathode side and 3.0 to >10 M at the anode side.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation).

A typical and well-known ionic liquid is formed by the combination of a 1-ethyl-3-methylimidazolium (EMI) cation and an N,N-bis(trifluoromethane) sulphonamide (TFSI) anion. This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF⁴⁻, B(CN)₄⁻, CH₃BF₃⁻, CH2CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃, N(SO₂CF₃)₂, N(COCF₃)(SO₂CF₃)⁻, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte ingredient (a salt and/or a solvent) in a Na—S cell.

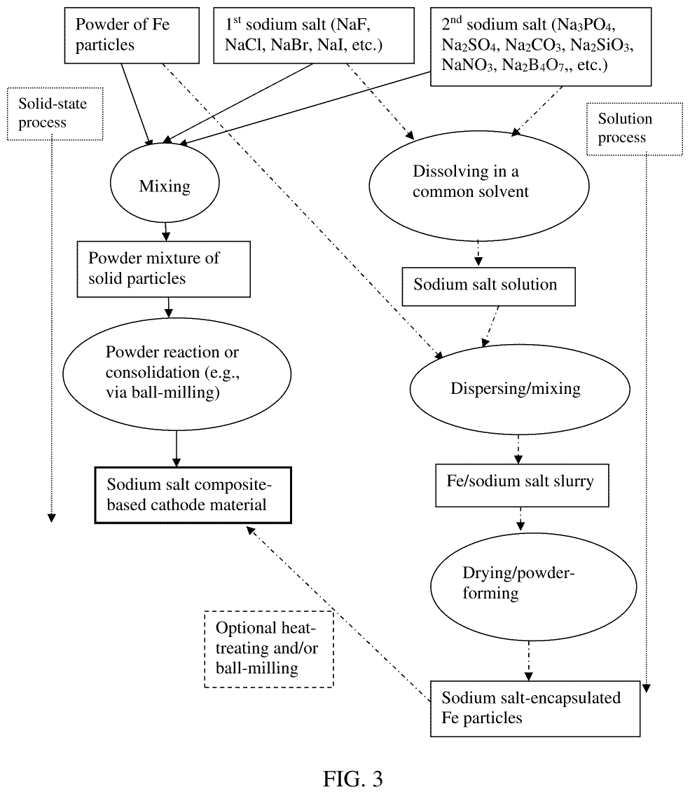

The present invention also provides a process for manufacturing the disclosed cathode active material, the process comprising: (a) providing Fe powder, a first sodium salt selected from NaF, NaCl, NaBr, NaI, or a combination thereof, and a second sodium salt selected from Na₃PO₄, Na₂SO₄, Na₂CO₃, Na₂SiO₃, NaNO₃⁻, Na₂B₄O₇, or a combination thereof; (b) mixing the Fe powder, the first sodium salt, and the second salt at a molar ratio of Fe-to-(combined first and second sodium salts) from 1/9 to 9/1 and a first-to-second sodium salt ratio from 1/3 to 3/1 to form a solid particle mixture; and (c) ball-milling the solid particle mixture at a first temperature under a protective atmosphere for a first period of time to obtain the desired sodium salt composite. This is illustrated in FIG. 3.

In certain embodiments, as schematically illustrated in the right-hand portion of FIG. 3, step b) comprises (i) dissolving the first sodium salt and the second sodium salt in a common liquid solvent to form a liquid salt solution; (ii) dispersing Fe particles, having a diameter or thickness from 5 nm to 10 μm, in the salt solution to form a slurry; and (iii) removing the liquid solvent to form a solid particle mixture. This is a solution-based process. The left-hand portion of FIG. 3 shows a dried, solid-state process.

Preferably, the step of removing the liquid solvent is conducted in such a manner that Fe particles are coated with or encapsulated by a solid layer of a mixture of the first sodium salt and the second sodium salt. This can be accomplished by using a procedure such as spray-drying, printing (e.g., inkjet printing), casting (to form a film which is possibly broken into particles using any mechanical breaking means, such as air jet milling), pan-coating, air-suspension coating or fluidized bed coating, centrifugal extrusion, vibrational nozzle coating, or a combination thereof. This step results in a highly homogeneous mixture of Fe particles and the first and second sodium salts, wherein Fe particles are always surrounded or contacted by the first and/or the second sodium salt, making a highly effective cathode active material that delivers the highest specific capacity.

The solvent removal and particle encapsulation procedure may be selected from spay-drying, pan-coating method, air-suspension coating method or fluidized bed coating, centrifugal extrusion, vibrational nozzle method, etc.

Pan-coating method: The pan coating process involves tumbling the active material particles in a pan or a similar device while the encapsulating material (e.g. sodium salt-liquid solvent solution) is applied slowly until a desired encapsulating shell thickness is attained.

Air-suspension coating method: In the air suspension coating process, the solid Fe particles (core material) are dispersed into the supporting air stream in an encapsulating chamber. A controlled stream of a sodium salt-solvent solution (plus an optional polymer) is concurrently introduced into this chamber, allowing the solution to hit and coat the suspended particles. These suspended particles are encapsulated (fully coated) with sodium salts (possibly bonded by a polymer, preferably an ion-conducting polymer) while the volatile solvent is removed, leaving a very thin layer of sodium salt composite on surfaces of these particles. This process may be repeated several hundred times until the required parameters, such as full-coating thickness (i.e. encapsulating shell or wall thickness), are achieved. The air stream which supports the particles also helps to dry them, and the rate of drying is directly proportional to the temperature of the air stream, which can be adjusted for optimized shell thickness.

In a preferred mode, the particles in the encapsulating zone portion may be subjected to re-circulation for repeated coating. The encapsulating chamber is arranged such that the particles pass upwards through the encapsulating zone, then are dispersed into slower moving air and sink back to the base of the encapsulating chamber, enabling repeated passes of the particles through the encapsulating zone until the desired encapsulating shell thickness is achieved.

Centrifugal extrusion: Fe particles may be encapsulated using a rotating extrusion head containing concentric nozzles. In this process, a stream of core fluid (slurry containing Fe particles dispersed in a solvent) is surrounded by a sheath of shell solution of sodium salts. As the device rotates and the stream moves through the air it breaks, due to Rayleigh instability, into droplets of core, each coated with the shell solution. While the droplets are in flight, the solvent may be evaporated from the wall solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle method: Core-shell encapsulation or matrix-encapsulation of iron (Fe) particles can be conducted using a laminar flow through a nozzle and vibration of the nozzle or the liquid. The vibration has to be done in resonance with the Rayleigh instability, leading to very uniform droplets. The liquid can include any liquids with limited viscosities (1-50,000 mPa·s): emulsions, suspensions or slurry containing the Fe particles. The solidification can be done according to the used gelation system with an internal gelation (e.g. sol-gel processing, melt) or an external (additional binder system, e.g. in a slurry).

Spray-drying: Spray drying may be used to encapsulate Fe particles when the particles are suspended in a sodium salt solution. In spray drying, the liquid feed (solution or suspension) is atomized to form droplets which, upon contacts with hot gas, allow solvent to get vaporized and thin sodium salt shell (with or without a polymer) to embrace the solid Fe particles.

The following examples are presented primarily for the purpose of illustrating the best mode practice of the present invention and should not be construed as limiting the scope of the present invention.

### Example 1: Sodium Metal Battery Containing a Fe/Sodium Salt Composite-Based Cathode and a Sodium Metal Anode

To prepare the iron/sodium salt composite, powders of Na₃PO₄, NaF, iron (Fe), and graphite were used. First, Na₃PO₄, NaF, and iron powder, in the molar ratio of 3:3:4, 6:3:7, and 3:6:5, respectively, were added to a planetary ball mill along with an additional 5-20 wt % graphite. Each solid powder mixture was sealed in an Ar-filled glove box with H₂O and O₂ concentrations below 0.1 part per million (ppm). The mixtures in a milling container were subjected to ball milling at 300 rpm for 48 hours, with a 5-min break every 30 min to control the chamber temperature. After opening up the lid to the container, we obtain a dark color mass of material that is basically a homogeneous blend or composite of Fe domains dispersed in a solid solution of Na₃PO₄ and NaF. Graphite was used to confer electrical conductivity to the cathode.

In order to determine the first-cycle specific capacity and efficiency, a cell configuration comprising a liquid electrolyte solution of 1 M NaPF₆ salt in EC/DEC, a layer of Na anode, a PE/PP copolymer separator, and the Fe/sodium salt composite-based cathode was tested. Both the anode current collector and cathode current collector were Al foil. The electrochemical testing results using a 100 mA/g current density indicate that this composite cathode can deliver a specific capacity of 275 mAh/g (based on the combined Fe/Na₃PO₄/NaF composite weight). This is exceptional and among the very best cathode active materials for sodium-ion cells.

Additionally, an electrolyte including 1.5M sodium bis(fluorosulfonyl)imide (NaFSI) salt in a solvent mixture of dimethyl carbonate (DMC) and tris(2,2,2-trifluoroethyl) phosphate (TFP) (1.5:2 in mole or 1.6:8.4 in wt.) was used in the sodium-ion cell. A first-cycle specific capacity of 292 mAh/g and a cycle life greater than 300 cycles (90% capacity retention) were observed.

### Example 2: Anode-Less Sodium Metal Battery (Initially Sodium-Free in the Anode) Containing a Sodium Salt Composite-Based Cathode

The sodium metal cells in this example were prepared in a similar manner as in Example 1, with the exception that the anode only consisted of an Al foil, without any sodium metal or other anode material coated on the Al current collector, when the cells were made. Such an anode-less sodium metal battery exhibited a high energy density since no anode active material was present prior to a charging procedure. Since no sodium metal was present, the fabrication of such a cell was significantly simpler and of lower cost. This is because the desired sodium ions to be shuttled between an anode and a cathode are stored in a stable cathode material, obviating the need to manufacture the battery in a highly environmentally controlled environment (free from the presence of moisture and oxygen). Such an environment would be expensive to maintain and operate.

### Example 3: Sodium Metal Battery Containing a Fe/Sodium Salt Composite (Prepared by a Sodium Salt Encapsulation Procedure) as a Cathode Active Material and a Sodium Metal Anode

The sodium metal cells were made in a similar manner as in Example 1, but the Fe/sodium salt composite was prepared through a solution approach. To prepare the iron/sodium salt composite, powders of Na₃PO₄, NaF, iron (Fe) powder, and graphite were used. First, Na₃PO₄ and NaF were dissolved in deionized water to form a sodium salt solution. Then, Fe particles and graphite were dispersed in this salt solution to form a slurry. Again, Na₃PO₄, NaF, and iron powder were mixed in the molar ratio of 3:3:4, 6:3:7, and 3:6:5, respectively. The slurry samples were then spray-dried to form Fe/sodium salt composite powders. Electron microscopic examinations indicate that Fe particles are surrounded or encapsulated by a mixture of Na 3PO₄ and NaF, and the salt-coated particles are in good contact with graphite.

Electrochemical tests demonstrate that this composite cathode can deliver a specific capacity of 316 mAh/g (based on the combined Fe/Na₃PO₄/NaF composite weight) when the electrolyte used was a liquid electrolyte solution of 1 M NaPF₆ salt in EC/DEC; this is significantly higher than the 275 mAh/g of the same Fe/sodium salt composite prepared by the solid-state ball milling procedure described in Example 1.

### Example 4: Lithium Battery Featuring a Cathode Comprising a Fe/Lithium Salt Composite Cathode Material

To prepare the iron/lithium salt composite, powders of Li₃PO₄, LiCl, iron (Fe) powder, and graphene sheets (from Angstron Materials, Inc.) were used. First, Li₃PO₄, LiCl, and iron powder, in the molar ratio of 3:3:4, 6:3:7, and 3:6:5, respectively, were added to a planetary ball mill along with an additional 5 wt % graphene sheets. Each solid powder mixture was sealed in an Ar-filled glove box with H₂O and O₂ concentrations below 0.1 part per million (ppm). The mixtures in a milling container were subjected to ball milling at 300 rpm for 48 hours, with a 5-min break every 30 min to control the chamber temperature. After opening up the lid to the container, we obtain a dark color mass of material that is basically a homogeneous blend or composite of Fe domains dispersed in a solid solution of Li₃PO₄ and LiCl.

A lithium-ion cell, comprising a Si-rich anode (GCA-Si from Honeycomb Battery Co.) having a 75% by weight of Si mixed with carbon (15%) and graphene sheets (10%) as an anode material and Fe/lithium salt composite as a cathode material. The separator was a PE/PP membrane and the electrolyte included 1.5M lithium bis(fluorosulfonyl)imide (LiFSI) salt in a solvent mixture of dimethyl carbonate (DMC) and tris(2,2,2-trifluoroethyl) phosphate (TFP) (1.5:2 in mole or 1.6:8.4 in wt.). A first-cycle specific capacity of 352 mAh/g was observed when a half-cell including the Fe/lithium salt composite as the working electrode and a 20-μm thick lithium foil was used as the counter-electrode.

### Example 5: Lithium Metal Cell Having an Elastic Polymer Composite Layer as a Separator and a Fe/Sodium-Lithium Salt Composite

To prepare the iron/sodium-lithium salt composite, powders of Na₃PO₄, Li₃PO₄, LiF, NaF, iron (Fe) powder, and graphene sheets (from Angstron Materials, Inc.) were used. First, Li₃PO₄, LiCl, and iron powder, in the molar ratio of 2:2:3:3:4, respectively, were added to a planetary ball mill along with an additional 5 wt % graphene sheets and 3% CNTs. The ball-milling conditions were similar to those described in Example 1.

For the preparation of a high-elasticity polymer separator, the ethoxylated trimethylopropane triacrylate monomer (ETPTA, Mw=428, Sigma-Aldrich) was dissolved in a solvent mixture of ethylene carbonate (EC)/diethyl carbonate (DEC), at a weight-based composition ratio of the ETPTA/solvent of 3/97 (w/w). Subsequently, benzoyl peroxide (BPO, 1.0 wt. % relative to the ETPTA content) as a radical initiator, along with a desired amount of selected sodium salt (e.g., sodium hexafluorophosphate, NaPF₆, or sodium borofluoride, NaBF₄), were added to allow for thermal crosslinking reaction upon deposition on a Cu foil surface. This layer of ETPTA monomer/initiator was then thermally cured at 60° C. for 30 min to obtain an elastomer separator layer.

For electrochemical testing, the working electrodes (cathode layers) were prepared by mixing 85 wt. % of sodium salt composite particles, 5 wt. % graphene sheets, 3% CNTs, and 7 wt. % polyvinylidene fluoride (PVDF) binder dissolved in N-methyl-2-pyrrolidinoe (NMP) to form a slurry of 5 wt. % total solid content. After coating the slurries on Al foil, the electrodes were dried at 120° C. in vacuum for 2 h to remove the solvent before pressing. Then, the electrodes were cut into a disk (ϕ=12 mm) and dried at 100° C. for 24 h in vacuum.

Electrochemical measurements were carried out using CR2032 (3V) coin-type cells with a sheet of Cu foil as an anode current collector, a lithium metal foil as an anode active material, an clastic composite separator, and 1 M LiPF₆ electrolyte solution dissolved in a mixture of ethylene carbonate (EC) and diethyl carbonate (DEC) (EC-DEC 1:1 v/v) to serve as a working electrode. The cell assembly was conducted in an argon-filled glove-box. The CV measurements were carried out using an electrochemical workstation at a scanning rate of 1 mV/s. The electrochemical performance of the cell featuring a high-elasticity polymer separator were evaluated by galvanostatic charge/discharge cycling at a current density of 100 mA/g using an Arbin electrochemical workstation. The capacity curves of the lithium metal cells were measured and the first-cycle specific capacity was found to be 285 mAh/g, an excellent value for a cathode active material.

### Example 6: Potassium Cells Comprising a Fe/Sodium Salt Composite-Based Cathode Active Material

For use as one of the cathode active materials (to be mixed with a Fe/sodium salt composite), the family of compounds, K₃(VOPO₄)₂F(KVPOF), were synthesized according to a procedure summarized below: Potassium metavanadate (KVO₃, ≥99%), potassium dihydrogen phosphate dihydrate (KH₂PO₄·2H₂O, ≥99%), and potassium fluoride (KF, ≥98%) were employed as vanadium, phosphorus, and fluorine resources, respectively, to synthesize KVPOF. Hydroxylamine (HONH₂·HCl) was used as a reductive agent. In a typical synthesis procedure for multi-shelled hollow NVPOF micro-spheres, 350 mL of 6 mol·L⁻¹ HONH₂·HCl was added into 700 mL of 1 mol·L⁻¹ NaVO₃. Then, H₂SO₄ was used to adjust pH to 3.5 to obtain a homogeneous transparent solution A. Additionally, 195 g of KH₂PO₄ and 25.9 g of KF were dissolved in the deionized water to obtain another solution, B. Finally, solution B was slowly added into the solution A under strong stirring. After stirring stopped, a light-blue precipitate started to appear after a few minutes. The reaction mixture was allowed to stand for some time. The obtained precipitate was washed with distilled water and dried at 110° C. in a vacuum overnight. This resulted in approximately 140 g of KVPOF powder.

The KVPOF powder was then mixed with the Fe/sodium salt composite obtained in Example 1 from powders of Na₃PO₄, NaF, iron (Fe), and graphite at a KVPOF/composite ratio of 3/1. This mixture was used as a cathode active material and a potassium film was used as an anode active material. The separator layer was a porous cellulose non-woven membrane impregnated with poly(propylene carbonate)-KFSI solid polymer electrolyte prepared by a liquid solution impregnation procedure.

### Example 7: Sodium-Ion Battery Containing a Fe/Sodium Salt Composite (Prepared by a Sodium Salt Encapsulation Procedure) as a Cathode Active Material and a Hard Carbon Anode

The sodium-ion cells were made in a similar manner as in Example 3, but the Fe/sodium salt composite was prepared through a solution approach using different sodium salts. To prepare the iron/sodium salt composite, powders of Na₂SO₄, NaF, iron (Fe) powder, and graphite were used. First, Na₂SO₄ and NaF were dissolved in deionized water to form a sodium salt solution. Then, Fe particles and graphite were dispersed in this salt solution to form a slurry. The Na₂SO₄, NaF, and iron powder were mixed at a molar ratio of 3:6:5. The slurry sample was then spray-dried to form Fe/sodium salt composite powders. Electron microscopic examinations indicate that Fe particles are surrounded or encapsulated by a mixture of Na₂SO₄ and NaF, and the salt-coated particles are in good contact with graphite. Electrochemical tests demonstrate that this composite cathode can deliver a specific capacity of 177 mAh/g (based on the combined Fe/Na₂SO₄/NaF composite weight) when the electrolyte used was a liquid electrolyte solution of 1 M NaPF₆ salt in EC/DEC.

1. A cathode active material for a rechargeable alkali metal battery, wherein said cathode active material comprises a sodium salt composite comprising a mixture or composite of Fe and at least a sodium salt selected from NaₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof, wherein a molar ratio of Fe-to-sodium salt is from 1/9 to 9/1.

2. The cathode active material of claim 1, wherein the sodium salt composite further meets at least one of the following criteria: (i) at least two anions, selected from the group consisting of F⁻, Cl⁻, Br⁻, I⁻¹, PO₄³⁻, SO₄²⁻, CO₃²⁻, SiO₃²⁻, NO₃⁻, and B₄O₇²⁻, form a solid solution; (ii) the mixture or composite further comprises at least a lithium salt selected from LiₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof; (iii) the mixture or composite further comprises at least a potassium salt selected from KₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof; and (iv) the mixture or composite further comprises a conductive material selected from graphite, hard carbon, soft carbon, carbon black, acetylene black, activated carbon, carbon fibers, carbon nanotubes, graphene sheets, or a combination thereof.

3. The cathode active material of claim 1, wherein a first anion selected from the group consisting of F⁻, Cl⁻, Br⁻, and I⁻¹ and a second anion selected from the group consisting of PO₄³⁻, SO₄²⁻, CO₃²⁻, SiO₃²⁻, NO₃⁻, and B₄O₇²⁻ form a solid solution.

4. A rechargeable alkali metal cell, comprising an anode, a cathode comprising the cathode active material of claim 1, a separator disposed between said cathode and said anode, and an electrolyte in ionic contact with the anode and the cathode, wherein the alkali metal cell is a sodium-ion cell, sodium metal cell, lithium-ion cell, lithium metal cell, potassium-ion cell, or potassium metal cell.

5. The rechargeable alkali metal cell of claim 4, wherein the anode has an anode current collector but initially the anode has no sodium, sodium alloy, lithium, lithium alloy, potassium, or potassium alloy as an anode active material supported by said anode current collector when the battery cell is made and prior to a charge or discharge operation of the battery.

6. The rechargeable alkali metal cell of claim 4, wherein the anode has an anode current collector and an amount of sodium, sodium alloy, lithium, lithium alloy, potassium, or potassium alloy, or a combination thereof as an anode active material supported by said anode current collector.

7. The rechargeable alkali metal cell of claim 4, wherein the electrolyte comprises a liquid organic electrolyte, ionic liquid electrolyte, gel polymer electrolyte, quasi-solid electrolyte having a sodium salt concentration higher than 2.0 M dispersed in a liquid, solid polymer electrolyte, inorganic solid electrolyte, composite electrolyte comprising particles of an inorganic solid dispersed in or bonded by a polymer, or a combination thereof, wherein the electrolyte has a sodium ion conductivity, lithium ion conductivity, or potassium ion conductivity no less than 10⁻⁶ S/cm.

8. The rechargeable alkali metal cell of claim 7, wherein the electrolyte comprises a lithium salt, a sodium salt, a potassium salt, or a combination thereof.

9. The rechargeable alkali metal cell of claim 7, wherein the electrolyte comprises a sodium salt selected from sodium perchlorate (NaClO₄), sodium chlorate (NaClO₃), sodium hexafluorophosphate (NaPF₆), sodium borofluoride (NaBF₄), sodium hexafluoroarsenide, sodium trifluoro-metasulfonate (NaCF₃SO₃), bis-trifluoromethyl sulfonylimide sodium (NaN(CF₃SO₂)₂), sodium trifluoromethanesulfonimide (NaTFSI), sodium bis(fluoroallyl) malonato borate salt (NaBFMB), sodium poly(tartaric acid)borate (NaPTAB) salt, NaCF₃COO, Na₂CO₃, Na₂O, Na₂C₂O₄, NaOH, NaX, ROCO₂Na, HCONa, RONa, (ROCO₂Na)₂, (CH₂OCO₂Na)₂, Na₂S, NaₓSO_{y}, wherein X=F⁻, Cl, I, or Br, R=a hydrocarbon group, x=0-1, y=1-4, or a combination thereof.

10. The rechargeable alkali metal cell of claim 7, wherein the electrolyte comprises a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

11. The rechargeable alkali metal cell of claim 7, wherein said electrolyte has a sodium ion conductivity, lithium ion conductivity, or potassium ion conductivity no less than 10⁻⁵ S/cm.

12. The rechargeable alkali metal cell of claim 7, wherein the electrolyte comprises a sodium ion-conducting polymer selected from poly(ethylene oxide) (PEO), Polypropylene oxide (PPO), polyethylene glycol (PEG), polyvinyl alcohol (PVA), poly(vinyl pyrrolidone) (PVP), poly(ethyl methacrylate) (PEMA), poly(acrylonitrile) (PAN), poly(methyl methacrylate) (PMMA), poly(vinylidene fluoride) (PVdF), Poly bis-methoxy ethoxyethoxide-phosphazenex, Polyvinyl chloride, Polydimethylsiloxane, poly(vinylidene fluoride)-hexafluoropropylene (PVDF-HFP), a sulfonated derivative thereof, or a combination thereof.

13. The rechargeable alkali metal cell of claim 7, wherein the electrolyte comprises a lithium ion-conducting polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanocthyl poly(vinyl alcohol), a pentaerythritol tetra-acrylate-based polymer, an aliphatic polycarbonate, a single Li-ion conducting solid polymer, poly(ethylene glycol) diacrylate, poly(ethylene glycol) methyl ether acrylate, polyurethane, polyurethane-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), polyphosphate, polyphosphonate, polyphosphinate, polyphosphine, polyphosphine oxide, a polymer synthesized from an ionic liquid, a copolymer thereof, a semi-penetrating network thereof, a sulfonated derivative thereof, or a combination thereof.

14. The rechargeable alkali metal cell of claim 7, wherein the electrolyte comprises an inorganic solid electrolyte selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof, or wherein the composite electrolyte comprises particles of a ceramic or glass material dispersed in a polymer and the particles are selected from SiO₂, TiO₂, Al₂O₃, MgO₂, ZnO₂, ZnO₂, CuO, CdO, Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F⁻, Cl, I, or Br, R=a hydrocarbon group, x=0-1, y=1-4.

15. The rechargeable alkali metal cell of claim 4, which is a sodium-ion cell wherein the anode has an anode active material other than or in addition to sodium or sodium alloy, wherein the anode active material is selected from meso-phase pitch, meso-phase carbon, meso carbon micro-beads (MCMB), coke particles (e.g., needle coke), expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, carbon black, amorphous carbon, activated carbon, templated carbon, hollow carbon nanowires, hollow carbon sphere, silicon (Si), phosphorus (P), sodium titanates, NaTi₂(PO₄)₃, Na₂Ti₃O₇, Na₂C₈H₄O₄, Na₂TP, NaₓTiO₂ (x=0.2 to 1.0), disodium terephthalate (Na₂C₈H₄O₄), carboxylate based materials, C₈H₄Na₂O₄, C₈H₆O₄, C₈H₅NaO₄, C₈Na₂F₄O₄,C₁₀H₂Na₁O₈, C₁₄H₄O₆, C₁₄H₄Na₄O₈, or a combination thereof.

16. The rechargeable alkali metal cell of claim 4, which is a sodium-ion cell wherein the anode has an anode active material selected from the group consisting of (a) sodium- or potassium-doped silicon (Si), germanium (Ge), tin (Sn), lead (Pb), antimony (Sb), bismuth (Bi), zinc (Zn), aluminum (Al), titanium (Ti), cobalt (Co), nickel (Ni), manganese (Mn), cadmium (Cd), and mixtures thereof; (b) sodium- or potassium-containing alloys or intermetallic compounds of Si, Ge, Sn, Pb, Sb, Bi, Zn, Al, Ti, Co, Ni, Mn, Cd, and their mixtures; (c) sodium- or potassium-containing oxides, carbides, nitrides, sulfides, phosphides, selenides, tellurides, or antimonides of Si, Ge, Sn, Pb, Sb, Bi, Zn, Al, Fe, Ti, Co, Ni, Mn, Cd, and mixtures or composites thereof; (d) sodium or potassium salts; and (e) graphene sheets pre-loaded or pre-attached with sodium ions.

17. The rechargeable alkali metal cell of claim 4, which is a sodium-ion cell wherein the anode has an anode active material comprising a carbon or graphite material having an inter-planar spacing d₀₀₂ value from 0.43 nm to 3.0 nm wherein the carbon or graphite material is selected from meso-phase pitch, meso-phase carbon, meso carbon micro-beads (MCMB), coke particles, expanded graphite flakes, artificial graphite particles, natural graphite particles, highly oriented pyrolytic graphite, soft carbon particles, hard carbon particles, multi-walled carbon nanotubes, carbon nano-fibers, carbon fibers, graphite nano-fibers, graphite fibers, carbonized polymer fibers, or a combination thereof, wherein the carbon or graphite material, without a chemical or physical expansion treatment, has an inter-planar spacing d₀₀₂ from 0.27 nm to 0.42 nm prior and the inter-planar spacing d₀₀₂.is increased to a value from 0.43 nm to 3.0 nm after the expansion treatment.

18. The rechargeable alkali metal cell of claim 17, wherein said carbon or graphite material is selected from graphite foam or graphene foam having pores and pore walls, wherein said pore walls contain a stack of bonded graphene planes having an expanded inter-planar spacing d₀₀₂ from 0.6 nm to 1.5 nm.

19. The rechargeable alkali metal cell of claim 17, wherein said expansion treatment includes a procedure selected from oxidation, fluorination, bromination, chlorination, nitrogenation, intercalation, combined oxidation-intercalation, combined fluorination-intercalation, combined bromination-intercalation, combined chlorination-intercalation, or combined nitrogenation-intercalation of said graphite or carbon material.

20. The rechargeable alkali metal cell of claim 17, wherein said carbon or graphite material contains a non-carbon element selected from oxygen, fluorine, chlorine, bromine, iodine, nitrogen, hydrogen, or boron.

21. The rechargeable alkali metal cell of claim 7, wherein said electrolyte contains a salt selected from an ionic liquid salt, sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-metasulfonate (NaCF₃SO₃), potassium trifluoro-metasulfonate (KCF₃SO₃), bis-trifluoromethyl sulfonylimide sodium (NaN(CF₃SO₂)₂), sodium trifluoromethanesulfonimide (NaTFSI), bis-trifluoromethyl sulfonylimide potassium (KN(CF₃SO₂)₂), a combination thereof, or a combination thereof with lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂, Lithium bis(oxalato)borate (LiBOB), lithium oxalyldifluoroborate (LiBF₂C₂O₄), lithium oxalyldifluoroborate (LiBF₂C₂O₄), Lithium nitrate (LiNO₃), Li-Fluoroalkyl-Phosphates (LiPF₃(CF₂CF₃)₃), or lithium bisperfluoroethysulfonylimide (LiBETI).

22. The rechargeable alkali metal cell of claim 7, wherein said electrolyte comprises a solvent selected from ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (Y-BL), acetonitrile (AN), ethyl acetate (EA), propyl formate (PF), methyl formate (MF), toluene, xylene or methyl acetate (MA), fluoroethylene carbonate (FEC), vinylene carbonate (VC), allyl ethyl carbonate (AEC), 1,3-dioxolane (DOL), 1,2-dimethoxyethane (DME), tetraethylene glycol dimethylether (TEGDME), Poly(ethylene glycol) dimethyl ether (PEGDME), diethylene glycol dibutyl ether (DEGDBE), 2-ethoxyethyl ether (EEE), sulfone, sulfolane, a room temperature ionic liquid, or a combination thereof.

23. The rechargeable alkali metal cell of claim 4, wherein the cathode further comprises an additional or second cathode active material selected from NaFePO₄, Na₍₁₋ₓ₎KₓPO₄, KFePO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ (Fe_{1/2}Mn_{1/2})O₂, NaₓMnO₂, λ-MnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56} Ni_{0.44}HCF, NIHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y}, y/z=0.01 to 100, Se, sodium polysulfide, sulfur, Alluaudites, or a combination thereof, wherein x is from 0.1 to 1.0.

24. The rechargeable alkali metal cell of claim 4, wherein the cathode further comprises a cathode active material selected from a Na-based layered oxide, a polyanionic compound, a mixed polyanionic compound, a sulfate, a pyrophosphate, a Prussian Blue analog, a Prussian White analog, or a combination thereof.

25. The rechargeable alkali metal cell of claim 4, wherein the cathode further comprises a cathode active material selected from Na_{0.7}CoO₂, Na_{0.67}Ni_{0.25}Mg_{0.1} Mn_{0.65}O₂, Na_{0.5}[Ni_{0.23}Fe_{0.13}Mn_{0.63}]O₂, Na_{0.85}Li_{0.17}Ni_{0.21}Mn_{0.64}O₂, Zn doped Na_{0.833}[Li_{0.25}Mn_{0.75}]O₂, Na_{0.7}Mg_{0.05}[Mn_{0.6}Ni_{0.2}Mg_{0.15}]O₂, Na_{0.66} Co_{0.5}Mn_{0.5}O₂, Na_{2/3}Li_{1/9}Ni_{5/18}Mn_{2/3}O₂, C-coated NaCrO₂, Na_{0.9}[Cu_{0.22}Fe_{0.30}Mn_{0.48}]O₂, Na[Ni_{0.58}Co_{0.06}Mn_{0.36}]O₂, Na_{0.75}Ni_{0.82}Co_{0.12}Mn_{0.06}O₂, NaMn_{0.48} Ni_{0.2}Fe_{0.3}Mg_{0.02}O₂, V₂O₅ nanosheet, Na₃V₂(PO₄)₃, Na₃V₂(PO₄)₃/C, Na₃MnZr(PO₄)₃, Na₄Fe₃(PO₄)₂(P₂O₇), Na₃MnTi(PO₄)₃/C, carbon coated Na₃V₂(PO₄)₂F₃, Na₃(VOPO₄)₂F, graphene oxide protected Na₂₊₂ₓFe₂₋ₓ(SO₄)₃, Na_{2.3}Cu_{1.1}Mn₂O_{7-d}, graphene oxide protected Na₂FeP₂O₇, graphene oxide protected Na_{0.81}Fe[Fe(CN)₆]_{0.79-0.61}, Na₂CoFe(CN)₆, Ni_{0.67}Fe_{0.33}Se₂, or a combination thereof.

26. The rechargeable alkali metal cell of claim 4, which is a lithium battery wherein the cathode active material further comprises at least a lithium salt selected from LiₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof.

27. A rechargeable alkali metal cell, comprising an anode, a cathode comprising a cathode active material, a separator disposed between said cathode and said anode, and an electrolyte in ionic contact with the anode and the cathode, wherein the alkali metal cell is a lithium-ion cell or lithium metal cell, and wherein the cathode active material comprises a lithium salt composite comprising a mixture or composite of Fe and at least a lithium salt selected from LiₓA, wherein x is from 1 to 3, and the anion A^{x-} is selected from Cl⁻, Br⁻, I⁻¹, PO₄³⁻, SO₄²⁻, CO₃²⁻, SiO₃²⁻, NO₃⁻, B₄O₇²⁻, a combination thereof, or a combination of Cl⁻, Br⁻, I⁻¹, SO₄²⁻, CO₃²⁻, SiO₃²⁻, NO₃⁻, or B₄O₇²⁻ with F.

28. The rechargeable alkali metal cell of claim 4, which is a potassium battery wherein the cathode active material further comprises at least a potassium salt selected from KₓA, wherein x is from 1 to 3, and the anion A^{x-} is selected from F⁻, Cl⁻, Br⁻, I⁻¹, PO₄³⁻, SO₄²⁻, CO₃²⁻, SiO₃²⁻, NO₃⁻, B₄O₇²⁻, or a combination thereof.

29.-33. (canceled)
